(19) United States
(12) Patent Application Publication
(10) Pub. No.: US 2025/0344074 A1
(43) Pub. Date: Nov. 6, 2025

(54) CONFIGURING A SPECTRUM CHANNEL BETWEEN A CENTRALIZED UNIT AND A DISTRIBUTED UNIT OF A FRONTHAUL OPTICAL NETWORK

(71) Applicant: AT&T Communications Services India Private Limited, Bangalore (IN)

(72) Inventor: Mritunjay Pandey, Bangalore (IN)

(21) Appl. No.: 18/656,556

(22) Filed: May 6, 2024

(51) Int. Cl. H04W 16/14; H04Q 11/00

(52) U.S. Cl. CPC H04W 16/14; H04Q 11/0067

(57) ABSTRACT

A method for configuring a spectrum channel between a centralized unit and a distributed unit of a fronthaul optical network of a wireless communications core network includes obtaining a set of parameters describing settings of the centralized unit and the distributed unit, executing a machine learning model trained to predict an optimal frequency of a spectrum channel for carrying data between the centralized unit and the distributed unit when the settings of the centralized unit and the distributed unit are configured in accordance with the set of parameters, identifying a spectrum channel of a path between the centralized unit and the distributed unit that supports the optimal frequency and sending commands to the centralized unit and the distributed unit that cause the settings of the centralized unit and the distributed unit to be configured to use the spectrum channel for carrying data between the centralized unit and the distributed unit.

The present disclosure relates generally to wireless communications core networks, and relates more particularly to devices, non-transitory computer-readable media, and methods for configuring a spectrum channel between a centralized unit and a distributed unit of a fronthaul optical network.

### BACKGROUND

Fifth Generation (5G) wireless networks are moving toward the disaggregation of the access network into centralized units (CUs), distributed units (DUs), and radio units (RUs) to support more diverse ecosystems of equipment. The CU and the DU generate digitized radio signals (and, thus, may be considered to perform the computational functions of a base station), while the RU transmits, receives, and amplifies the digitized signals (and, thus, may be located near or integrated with the base station antenna). The DU and RU may be collocated, or at least located in physical proximity to each other, while the CU may be physically located remotely from the DU and RU (e.g., in the core network). In general, there is a one-to-one correspondence between CUs and base stations (e.g., gNodeBs), but a one-to-potentially many correspondence between CUs and DUs. For instance, a single CU may control one hundred or more DUs.

### SUMMARY

In one example, the present disclosure describes a device, computer-readable medium, and method for configuring a spectrum channel between a centralized unit and a distributed unit of a fronthaul optical network. For instance, in one example, a method includes obtaining a set of parameters describing settings of a centralized unit and a distributed unit of a fronthaul optical network of a wireless communications core network, executing a machine learning model that is trained to predict an optimal frequency of a spectrum channel for carrying data between the centralized unit and the distributed unit when the settings of the centralized unit and the distributed unit are configured in accordance with the set of parameters, identifying a spectrum channel of a path between the centralized unit and the distributed unit that supports the optimal frequency and sending commands to the centralized unit and the distributed unit that cause the settings of the centralized unit and the distributed unit to be configured to use the spectrum channel of the path for carrying data between the centralized unit and the distributed unit.

In another example, a non-transitory computer-readable medium stores instructions which, when executed by a processing system of a wireless communications core network including at least one processor, cause the processing system to perform operations. The operations include obtaining a set of parameters describing settings of a centralized unit and a distributed unit of a fronthaul optical network of the wireless communications core network, executing a machine learning model that is trained to predict an optimal frequency of a spectrum channel for carrying data between the centralized unit and the distributed unit when the settings of the centralized unit and the distributed unit are configured in accordance with the set of parameters, identifying a spectrum channel of a path between the centralized unit and the distributed unit that supports the optimal frequency and sending commands to the centralized unit and the distributed unit that cause the settings of the centralized unit and the distributed unit to be configured to use the spectrum channel of the path for carrying data between the centralized unit and the distributed unit.

In another example, a system includes a processing system of a wireless communications core network including at least one processor and a non-transitory computer-readable medium storing instructions which, when executed by the processing system, cause the processing system to perform operations. The operations include obtaining a set of parameters describing settings of a centralized unit and a distributed unit of a fronthaul optical network of the wireless communications core network, executing a machine learning model that is trained to predict an optimal frequency of a spectrum channel for carrying data between the centralized unit and the distributed unit when the settings of the centralized unit and the distributed unit are configured in accordance with the set of parameters, identifying a spectrum channel of a path between the centralized unit and the distributed unit that supports the optimal frequency and sending commands to the centralized unit and the distributed unit that cause the settings of the centralized unit and the distributed unit to be configured to use the spectrum channel of the path for carrying data between the centralized unit and the distributed unit.

### BRIEF DESCRIPTION OF THE DRAWINGS

The teachings of the present disclosure can be readily understood by considering the following detailed description in conjunction with the accompanying drawings, in which:

FIG. 1A illustrates an example system in which examples of the present disclosure for configuring a spectrum channel between a centralized unit and a distributed unit of a fronthaul optical network may operate;

FIG. 1B illustrates another example system in which examples of the present disclosure for configuring a spectrum channel between a centralized unit and a distributed unit of a fronthaul optical network may operate;

FIG. 2 illustrates a flowchart of an example method for training a machine learning model to configure an optimal channel for connecting a centralized unit to a distributed unit in a Fifth Generation optical fronthaul network;

FIG. 3 illustrates a flowchart of an example method for configuring an optimal channel for connecting a centralized unit to a distributed unit in a Fifth Generation optical fronthaul network; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium for configuring a spectrum channel between a centralized unit and a distributed unit of a fronthaul optical network. As discussed above, Fifth Generation (5G) wireless networks are moving toward the disaggregation of the access network into centralized units (CUs), distributed units (DUs), and radio units (RUs) to support scaling and more diverse ecosystems of equipment. In some cases, a fronthaul optical network, e.g., a wavelength division multiplexing (WDM) network or passive optical network (PON) may be deployed between the CUs and DUs of the 5G access network. The signal strength of a spectrum channel of a path between a CU and a DU in the fronthaul optical network may be affected by various parameters, including the distance between the CU and DU, the gain profile of the optical fiber connection of the path, absorption losses in the optical fiber connection, scatterings (e.g., Rayleigh, Mie, or the like) in the optical fiber connection, the dispersion profiles (e.g., chromatic, polarization mode dispersion, model, or the like) of the optical fiber connection, and other optical fiber characteristics. Poor signal strength in the connection between a CU and a DU may lead to signal drop and outages in the fronthaul optical network and the larger access network.

Moreover, if all WDM spectrum channels on a particular path of the fronthaul optical network are exhausted, then there is currently no way to handle on-demand traffic on that path. In other examples, the WDM spectrum may not have enough available space to accommodate on-demand traffic. In other examples, changes in the optical characteristics of the fronthaul optical network may create obstacles for the launch of new spectrum channels and may also negatively affect existing spectrum channels. For instance, the addition of additional high-capacity spectrum channels may cause refractive index changes (due to non-linearity), polarization mode dispersion may be caused by fiber twists, and amplified spontaneous emission (ASE) noise changes may be caused by increased amplification needs (e.g., changing laser characteristics over time).

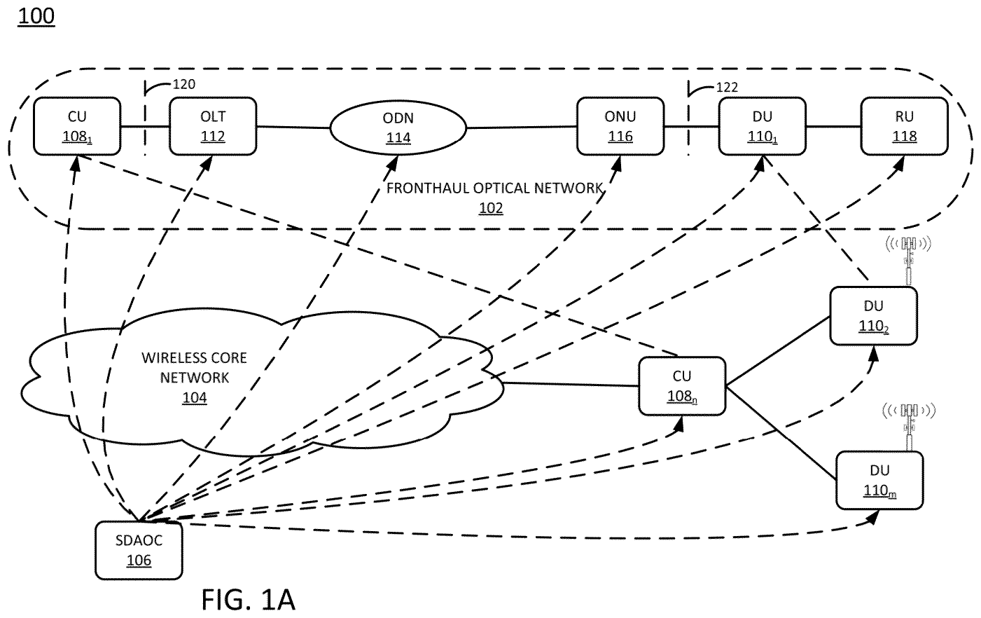

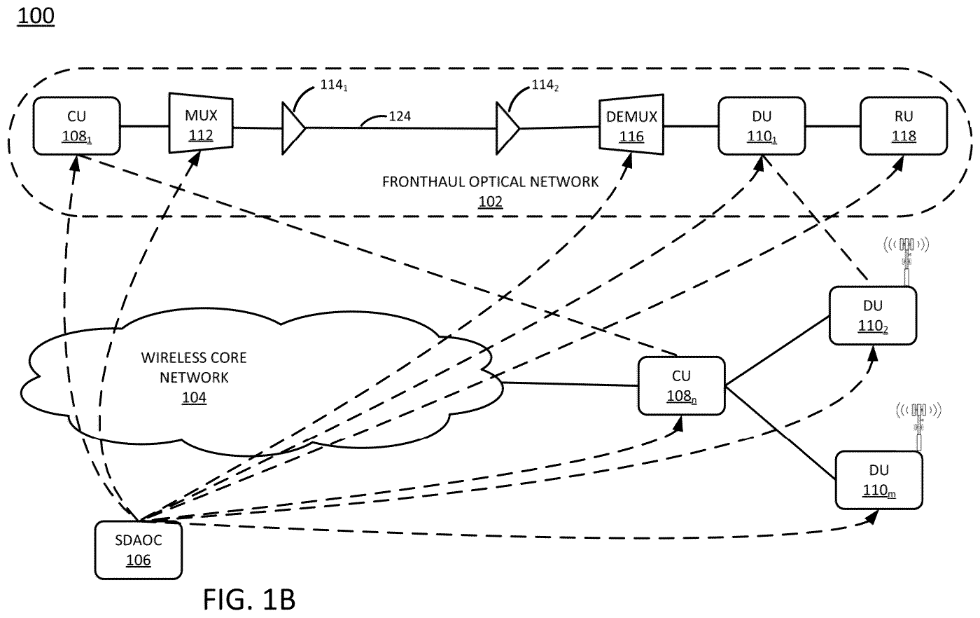

Examples of the present disclosure provide a software defined access optical controller (SDAOC) and method that learn the physical characteristics of a 5G fronthaul optical network and store those physical characteristics in a database. In further examples, various applications may access the database to predict the spectral efficiency needs of resources of the fronthaul optical network, such as the required signal strength to ensure reliable transmissions between CUs and DUs of the fronthaul optical network. Spectrums channels having frequencies capable of supporting these spectral efficiency needs may be selected (or newly launched) to connect the CUs and DUs. In further examples, the SDAOC may predict whether a current configuration of the fronthaul optical network provides sufficient spectral efficiency to support a predicted future demand on the fronthaul optical network, based on the collected physical characteristics. Thus, examples of the present disclosure are able to maximize utilization of the WDM spectrum while minimizing operating expenses by predicting the spectral efficiencies of spectrum channels between a CU and a DU and recommending the optimal spectrum channel to carry communications between the CU and the DU. These and other aspects of the present disclosure are discussed in further detail with reference to FIGS. 1A-4, below.

To further aid in understanding the present disclosure, FIG. 1A illustrates an example system 100 in which examples of the present disclosure for configuring a spectrum channel between a centralized unit and a distributed unit of a fronthaul optical network may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VOIP) networks, Service over IP (SoIP) networks, the World Wide Web, and the like. In one example, the system 100 generally comprises a wireless core network 104, a fronthaul optical network 102, and a software defined access optical controller (SDAOC) 106.

In one example, the wireless core network 104 may functionally comprise a fixed mobile convergence (FMC) network, e.g., an IP Multimedia Subsystem (IMS) network. In addition, the wireless core network 104 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one particular example, the wireless core network 104 is a 5G core network that may include a plurality of centralized units (CUs) 108₁-108ₙ (hereinafter individually referred to as a “CU 108” or collectively referred to as “CUs 108”), distributed units (DUs) 110₁-110ₘ (hereinafter individually referred to as a “DU 110” or collectively referred to as “CUs 110”), and radio unit 118. In one example, CUs 108, DUs 110, and RU 118 may be connected to each other via wired (e.g., optical fiber) connections (illustrated in FIG. 1B as solid lines, whereas wireless connections are illustrated as dashed lines).

In one example, the fronthaul optical network 102 is a passive optical network (PON), such as a 25G or 50G PON or a higher speed XGS-PON. A PON is a fiber broadband network that utilizes a type of fiber deployment in which no electrical hardware is deployed in the fiber plant. Thus, where the fronthaul optical network 102 is a PON, the fronthaul optical network may include at least one optical line terminal (OLT) 112. The OLT 112 may be part of a central office of the PON, e.g., a hub or centrally located point in the system 100 at which a conglomerate signal is distributed to optical nodes (e.g., in neighborhoods or premises locations). The conglomerate signal may carry voice, data, and/or video services to the customer sites in the PON. Thus, the OLT 112 comprises the starting point of the fronthaul optical network 102.

The termination point of the fronthaul optical network 102 may include at least one optical network unit (ONU) 116. In fiber-to-the-premises (FTTP) connections, the fiber optic cable runs all the way into the customer sites and is connected directly to an ONU, which converts fiber signals (i.e., pulses of light) into data that can be rendered by user endpoint devices at the customer site, such as personal computers, set top boxes, smart televisions, and the like.

An optical distribution network (ODN) 114 may reside between the OLT 112 and the ONU 116 and provide the physical path for optical transmission between the OLT 112 and the ONU 116. To this end, the ODN 114 may include a plurality of optical fibers, fiber optic connectors, passive optical splitters, and auxiliary components (not shown). Collectively, the OLT 112, ODN 114, and ONU 116 form the PON of the fronthaul optical network 102.

In one example, the fronthaul optical network 102 may connect a CU 108 of the system 100 (e.g., CU 108₁) to a DU 110 of the system 100 (e.g., DU 110₁) and an RU (e.g., RU 118). A first point to point interface, such as a first F1 interface 120, may connect the CU 108₁ to the OLT 112. Similarly, a second point to point interface, such as a second F1 interface 122, may connect the DU 110₁ to the ONU 116.

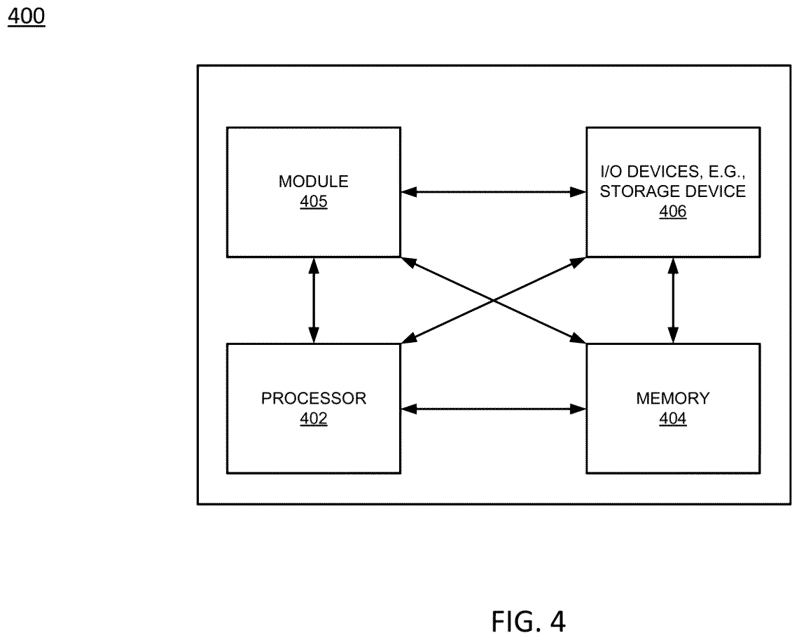

In one example, the SDAOC 106 may be configured in a manner similar to the computing system 400 illustrated in FIG. 4 and described in further detail below. In one example, the SDAOC 106 may include a processing system that trains and executes a machine learning model to predict an optimal spectrum channel between a CU 108 of the system 100 and a DU 110 of the system 100. To this end, the SDAOC 106 may collect data from the CUs 108, the DUs 110, the RU 118, and various components of the fronthaul optical network 102 including the OLT 112, ODN 114, and ONU 116. The SDAOC 106 may utilize the collected data to learn a topology of the system 100.

In further examples, the SDAOC may gather training data for the machine learning model by executing services in the system while specified combinations of parameters are deployed in the CUS 108, the DUs 110, the RU 118, and various components of the fronthaul optical network 102. The training data may be used to train the machine learning model to predict an optimal spectrum channel for transmissions between a CU 108 of the system 100 and a DU 110 of the system 100.

FIG. 1B illustrates another example system 100 in which examples of the present disclosure for configuring a spectrum channel between a centralized unit and a distributed unit of a fronthaul optical network may operate. The system 100 of FIG. 1B is configured in a manner similar to the system 100 of FIG. 1A; as such, the same reference numerals have been used to refer to elements that are common between FIG. 1A and FIG. 1B. However, in the example of FIG. 1B, the fronthaul optical network 102 may comprise a WDM network rather than a PON.

In a conventional WDM architecture, signals transmitted between the CU 108₁ and the DU 110₁ (e.g., along optical fiber 124) may be processed by amplifiers (e.g., amplifiers 114₁ and 114₂) and multiplexers (e.g., multiplexer 112 and demulitplexer 116), which would receive as input multiple signals of different wavelengths and combine those multiple signals into a single combined signal containing all of the multiple wavelengths. For instance, CU 108₁ could output its respective transmission signals to a multiplexer 112 which may combine the transmission signals with transmission signals received from other sources (e.g., network elements) to produce one or more combined signals. On the receive side, the demultiplexer 116 may separate a combined signal into a plurality of signals of different wavelengths and deliver one or more signals of the plurality of signals to the DU 110₁.

The WDM may include one or more of: a flexible modulation format, adaptive forward error correction (FEC), a coherent multiple input multiple output (MIMO) receiver, a flexible data rate, or a flexible data type. In one example, the WDM may be capable of tuning channels and bandwidth and optimizing reachability.

It should be noted that the system 100 has been simplified. Thus, those skilled in the art will realize that the system 100 may be implemented in a different form than that which is illustrated in FIG. 1A or FIG. 1B, or may be expanded by including additional endpoint devices, access networks, network elements, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

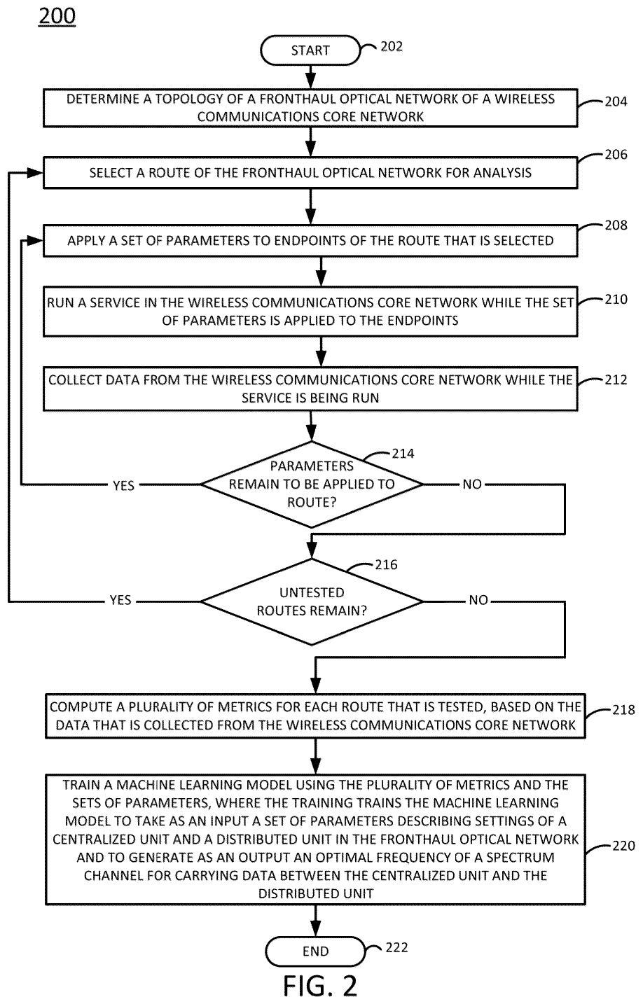

To further aid in understanding the present disclosure, FIG. 2 illustrates a flowchart of an example method 200 for training a machine learning model to configure an optimal channel for connecting a centralized unit to a distributed unit in a Fifth Generation optical fronthaul network. In one example, the method 200 may be performed by a network controller, such as the SDAOC 106 illustrated in FIG. 1A and FIG. 1B, or one or more components of the SDAOC 106. However, in other examples, the method 200 may be performed by another device, such as the computing system 400 of FIG. 4, discussed in further detail below. For the sake of discussion, the method 200 is described below as being performed by a processing system (where the processing system may comprise a component of an SDAOC, the computing system 400, or another device).

The method 200 begins in step 202. In step 204, the processing system may determine a topology of a fronthaul optical network of a wireless communications core network.

In one example, the wireless communications core network may be a 5G core network, and the fronthaul optical network may be a passive optical network or a wavelength division multiplexing network. The topology may include a plurality of network elements (e.g., centralized units, distributed units, and radio units, as well as multiplexers, demultiplexers, optical line terminals, optical distribution networks, optical network units, and the like), as well as wired and wireless paths between the network elements. In one example, wired paths may include optical fiber connections. The processing system may determine the physical locations of these network elements and paths (including the distances between the network elements and the physical lengths of the paths), as well as settings, capabilities, and features of the network elements and paths.

In one example, the capabilities of the network elements that are determined by the processing system may include at least one of: a supported data rate, a supported modulation format, a supported forward error correction technique (e.g., standard, enhanced, adaptive, etc.), or a supported data type (e.g., Ethernet, optical transport network, fiber channel, etc.).

In one example, the capabilities of the paths that are determined by the processing system may include the frequencies of any spectrum channels that are part of those paths.

In step 206, the processing system may select a route of the fronthaul optical network for analysis. In one example, a route may comprise a series of one or more wired and/or wireless paths that connect endpoints of the fronthaul optical network, where the endpoints may include a first network element and a second network element. In one example, the first network element may be a CU and the second network element may be a DU. Wired paths of the route may include optical fiber connections, and any optical fiber connection may support a plurality of spectrum channels. The plurality of spectrum channels may include multiple spectrum channels of different frequencies.

In step 208, the processing system may apply a set of parameters to endpoints of the route that are selected. As discussed above, the endpoints of the route that are selected may include a CU and a DU that are connected by the route. In one example, the parameters that are applied to the endpoints may comprise specific settings or values for any of the capabilities that are determined in step 204. For instance, the processing system may send a command to each of the endpoints, where the command instructs an endpoint to apply specific settings or values for data rate, modulation format, forward error correction technique, and/or data type. The specific settings or values may be predefined for a particular service (e.g., software application) that is to run in the wireless communications core network. For instance, a first service may be associated with a first set of settings or values for the capabilities, while a second service may be associated with a second, different set of settings or values for the same capabilities. Thus, in one example, if a service is specified, the processing system may select (e.g., by looking up in a lookup table or similar data structure) a predefined set of settings or values that is associated with the specified service.

In step 210, the processing system may run a service in the wireless communications core network while the set of parameters is applied to the endpoints. In one example, the service may be a service that is associated (e.g., in a lookup table or similar data structure) with the set of parameters, as discussed above. For instance, the service may comprise a mobile data service, a voice calling service, a content distribution (e.g., media streaming) service, or another type of service.

In step 212, the processing system may collect data from the wireless communications core network while the service is being run. In one example, the data that is collected in step 212 may include metrics that indicate the signal strengths of the one or more paths in the route that is selected in step 206. For instance, the data that is collected in step 212 may include the bandwidth of one or more spectrum channels of the one or more paths, the latency of the one or more spectrum channels, a signal drop rate of the one or more spectrum channels, or another metric.

In step 214, the processing system may determine whether any sets of parameters remain to be applied to the route that is selected. For instance, as discussed above, different sets of parameters may be associated with different services that may run in the wireless communications core network. Thus, an operator of the wireless communications core network may wish to test how different services may place different demands (e.g., in terms of network traffic) on the wireless communications core network and/or the fronthaul optical network. In further examples, a service may be associated with multiple different sets of parameters, such as where the service may be a subscription service that offered multiple different tiers of service at different price points. Thus, the operator of the wireless communications core network may wish to test how the different tiers of service for the same service may place different demands on the wireless communications core network and/or the fronthaul optical network.

In one example, prior to the method 200 being initiated, the operator of the wireless communications core network may define a list of sets of parameters that are to be tested in accordance with the method 200, and the processing system may work its way through the list, one set of parameters at a time (e.g., iterating through steps of the method 200 as necessary).

If the processing system concludes in step 214 that there are sets of parameters that remain to be applied to the route that is selected, then the method 200 may return to step 208 and select a new set of parameters to apply to the route that is selected. Steps 210-214 may then be repeated as discussed above.

If, however, the processing system concludes in step 214 that there are no sets of parameters that remain to be applied to the route that is selected, then the method 200 may proceed to step 216. In step 216, the processing system may determine whether any untested routes remain.

As discussed above, the wireless communications core network and the fronthaul optical network may comprise a plurality of routes, and each route may include one or more paths (e.g., wired and/or wireless connections), such that there may be multiple possible ways to connect any given pair of network elements. In one example, the processing system may test every route of the wireless communications core network when performing the method 200 (iterating through steps of the method 200 as necessary), so that the impacts of various services and parameter configurations on the entire wireless communications core network can be determined.

If the processing system concludes in step 216 that there are untested routes that remain to be tested, then the method 200 may return to step 206 and select a new route for analysis. Steps 208-216 may then be repeated as discussed above.

If, however, the processing system concludes in step 216 that there are no untested routes that remain to be tested, then the method 200 may proceed to step 218. In step 218, the processing system may compute a plurality of metrics for each route that was tested in steps 206-216, based on the data that is collected in step 212.

In one example, the plurality of metrics may include at least one of: spectral efficiency, asymptotic power efficiency, average energy (e.g., per bit transferred along route), signal attenuation (e.g., per unit length of route), simulated Brillouin scattering (SBS), simulated Raman scattering (SRS), and Rayleigh scattering.

In one example, the spectral efficiency (SE) of a route may be calculated for all combinations of modulation formats and data rate on the route. In one example, SE may be calculated, for any combination of modulation format and data rate, as:

$$SE = {Log}_{2} ( M ) \div ( N / 2 ) \qquad ( EQN . 1 )$$

where M represents a number of symbols of the modulation format, and N represents the dimensionality of the modulation format.

In one example, the asymptotic power efficiency (APE) of a route may be calculated as:

$$APE = γ = \frac{{d}_{min}^{2}}{4 {E}_{b}} = \frac{{d}_{min}^{2} {log}_{2} ( M )}{4 {E}_{s}} \qquad ( EQN . 2 )$$

where d represents the diameter of the optical fiber core of the route (e.g., measured in micrometers), E_{b} represents the energy per bit traversing the route, and Eₛ represents the average symbol rate of the modulation format and may be calculated as:

$${E}_{s} = \frac{1}{M} {\sum }_{k = 1}^{M} {‖ {c}_{k} ‖}^{2} \qquad ( EQN . 3 )$$

where cₖ represents the k^{th} symbol rate. The value of cₖ may vary from k−1 to M.

In one example, the average energy A E_{b} may be calculated, per bit of data transferred along the route, as:

$$A {E}_{b} = {E}_{s} / {log}_{2} ( M ) \qquad ( EQN . 4 )$$

In one example, the signal attenuation per unit length of a route α_{dB} of a route may be calculated (e.g., in decibels per kilometer) as:

$${α}_{dB} * L = 10 {log}_{10} \frac{Pi}{Po} \qquad ( EQN . 5 )$$

where L is the optical length of the route, Pi is the launch power of the route, and Po is the received power of the route.

In one example, the simulated Brillouin scattering P_{B} of a route may be calculated in watts as:

$${P}_{B} = 4.4 \times {10}^{- 3} {d}^{3} {λ}^{2} {α}_{dB} v \qquad ( EQN . 6 )$$

where λ is the operating wavelength of the optical fiber core of the route (e.g., measured in micrometers) and v is the bandwidth of an injection laser of the route.

In one example, the simulated Raman scattering PR of a route may be calculated as:

$${P}_{R} = 5.9 \times {10}^{- 2} {d}^{2} {λα}_{dB} \qquad ( EQN . 7 )$$

In one example, setting of SBS and SRS thresholds may help to control the launch powers of spectrum channels to minimize SBS and SRS.

In one example, Rayleigh scattering (for which the coefficient is Γ_{R}) may be calculated according to:

$${Γ}_{R} = \frac{8 {π}^{3}}{3 {λ}^{4}} {n}^{8} p 2 {β}_{C} {KT}_{F} \qquad ( EQN . 8 )$$

where n represents the refractive index of the optical fiber core of a route, p represents an average photo-elastic coefficient, β_{C} represents the isothermal compressibility of the optical fiber core at a fictive temperature T_{F}, and K represents Boltzmann's constant. Thus, for an optical fiber core having a constant refractive index, all parameters of EQN. 8 will likewise be constant, and the Rayleigh scattering will depend completely on the wavelength of the light passing through the optical fiber core.

In step 220, the processing system may train a machine learning model using the plurality of metrics and the sets of parameters, where the training trains the machine learning model to take as an input a set of parameters describing settings of a centralized unit and a distributed unit of the fronthaul optical network and to generate as an output an optimal frequency of a spectrum channel for carrying data between the centralized unit and the distributed unit.

In one example, the machine learning model may be based on any one or more of: a decision tree, a random forest algorithm, a naïve Bayes algorithm, a support vector machine, a gradient boost algorithm, a neural network, a nearest neighbor algorithm, a linear regression algorithm, or another type of machine learning technique.

Once trained, the machine learning model will predict, for an input combination of parameters describing the settings of any CU/DU pair in the fronthaul optical network, an optimal frequency of a spectrum channel for carrying data between the CU and the DU. In one example, an optimal frequency may be one that is sufficient to minimize both signal drop on a path between the CU and DU and wastage of resources on the path. For instance, an optimal frequency may ensure that signal drop does not exceed a threshold rate, but also seek to ensure that no more than a threshold amount of resources associated with the frequency go unused over a period of time.

The method 200 may end in step 222. However, in some examples, the method 200 may be repeated periodically, or in response to a network event such as a change in the topology of the wireless communications core network (e.g., addition or removal of a network element or path, hardware or software updates that alter the capabilities of network elements or paths, or the like) or a change in the services that run in the network (e.g., deployment of a new service or a new feature of an existing service)

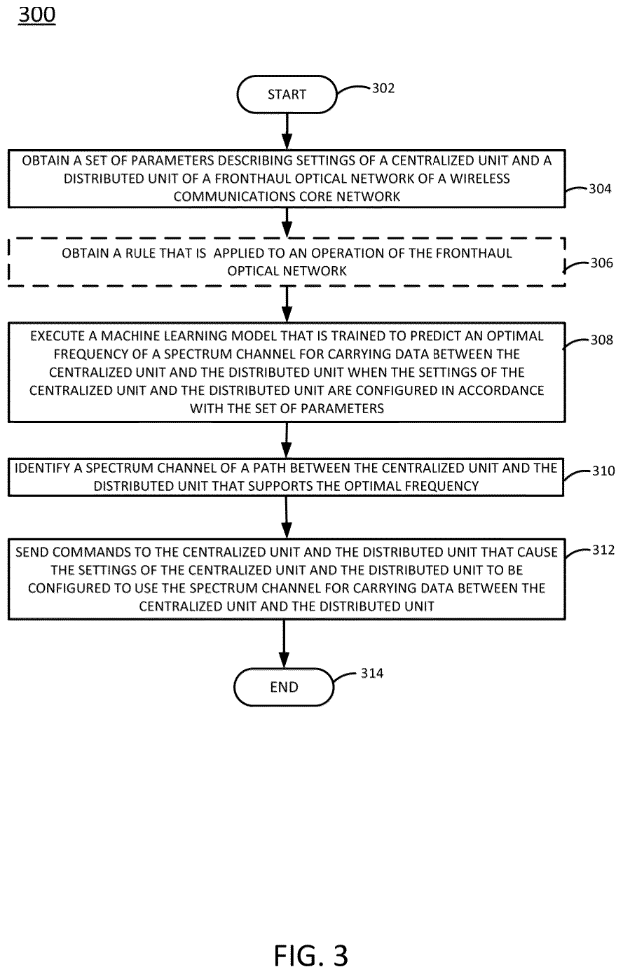

FIG. 3 illustrates a flowchart of an example method 300 for configuring an optimal channel for connecting a centralized unit to a distributed unit in a Fifth Generation optical fronthaul network. In one example, the method 300 may be performed by a network controller, such as the SDAOC 106 illustrated in FIG. 1A and FIG. 1B, or one or more components of the SDAOC 106. However, in other examples, the method 300 may be performed by another device, such as the computing system 400 of FIG. 4, discussed in further detail below. For the sake of discussion, the method 300 is described below as being performed by a processing system (where the processing system may comprise a component of an SDAOC, the computing system 400, or another device).

The method 300 begins in step 302. In step 304, the processing system may obtain a set of parameters describing settings of a centralized unit and a distributed unit of a fronthaul optical network of a wireless communications core network.

In one example, the wireless communications core network may be a 5G core network, and the fronthaul optical network may be a passive optical network or a wavelength division multiplexing network. The topology of the fronthaul optical network may include a plurality of network elements (e.g., centralized units, distributed units, and radio units, as well as multiplexers, demultiplexers, optical line terminals, optical distribution networks, optical network units, and the like), as well as wired and wireless paths between the network elements. In one example, wired paths may include optical fiber connections. The physical locations of these network elements and paths (including the distances between the network elements and the physical lengths of the paths), as well as settings, capabilities, and features of the network elements and paths, may be known to the processing system.

In one example, the parameters may identify specific values for the settings of the centralized unit and the distributed unit. In one examples, the settings may relate to data rate, modulation format, forward error correction technique, and/or data type. The values may be associated with a particular service (e.g., software application) that runs in the wireless communications core network.

In optional step 306 (illustrated in phantom), the processing system may obtain a rule that is applied to an operation of the fronthaul optical network.

In one example, the rule may comprise a requirement imposed by an operator of the wireless communications core network, such as a service level agreement with the operator's customers. Thus, in some examples, the rule may specify threshold performance metrics that the wireless communications core network (and, by extension, the fronthaul optical network) is to satisfy.

In step 308, the processing system may execute a machine learning model that is trained to predict an optimal frequency of a spectrum channel for carrying data between the centralized unit and the distributed unit when the settings of the centralized unit and the distributed unit are configured in accordance with the set of parameters.

As discussed above, the machine learning model may be based on any one or more of: a decision tree, a random forest algorithm, a naïve Bayes algorithm, a support vector machine, a gradient boost algorithm, a neural network, a nearest neighbor algorithm, a linear regression algorithm, or another type of machine learning technique.

In one example, the machine learning model may predict, for the set of parameters of the centralized unit and the distributed unit, an optimal frequency of a spectrum channel for carrying data between the CU and the DU. In one example, an optimal frequency may be one that is sufficient to minimize both signal drop on a path between the CU and DU and wastage of resources on the path. For instance, an optimal frequency may ensure that signal drop does not exceed a threshold rate, but also seek to ensure that no more than a threshold amount of resources associated with the frequency go unused over a period of time.

In one example, where a rule is obtained in step 306, the rule may be provided as an additional input to the machine learning model in step 308. Thus, the optimal frequency that is predicted by the machine learning model may account for any limitations, thresholds, or other requirements that may be imposed by the rule.

In step 310, the processing system may identify a spectrum channel of a path between the centralized unit and the distributed unit that supports the optimal frequency. In one example, a path (e.g., an optical fiber core) connecting the centralized unit and the distributed unit may contain a plurality of spectrum channels of different frequencies (or ranges of frequencies). The processing system may analyze the plurality of spectrum channels to identify a spectrum channel of the plurality of spectrum channels that matches (or most nearly matches) the optimal frequency.

In another example, if none of the available spectrum channels supports the optimal frequency, the processing system may take actions to establish a new spectrum channel on the path (or on a new path between the CU and the DU). The new spectrum channel may be configured to support the optimal frequency.

In step 312, the processing system may send commands to the centralized unit and the distributed unit that cause the settings of the centralized unit and the distributed unit to be configured to use the spectrum channel for carrying data between the centralized unit and the distributed unit.

In one example, the commands may be encoded in one or more data packets that may be transmitted from the processing system to the CU and the DU via a wired and/or wireless network connection. When the CU carries out the command from the processing system, the CU will establish a connection to the spectrum channel; likewise, when the DU carries out the command from the processing system, the DU will establish a connection to the spectrum channel. Thus, the commands will cause the CU and the DU to connect to each other via the spectrum channel, so that any data that passes between the CU and the DU will be carried over the spectrum channel, which has been identified as an optimal channel for connecting the CU and DU.

The method 300 may end in step 314. However, it will be appreciated that the method 300 may be repeated for other pairs of centralized units and distributed units in the fronthaul optical network. For instance, the method 300 may be repeated for all pairs of CUs and DUs that communicate (e.g., each CU and all DUs controlled by the CU). This will ensure that all connections between CUs and DUs in the fronthaul optical network are utilizing their respective optimal channels, which will optimize performance and improve customer experience by minimizing signal drop. In some cases, this may result in the frequency of a spectrum channel between a given CU and a first DU being different that the frequency of a spectrum channel between the same given CU and a second DU, different from the first DU.

In further examples, the processing system may learn, through execution of the method 300 over time, when the demands (e.g., in terms of network traffic or other data exchanged) on the spectrum channel connecting a CU and a DU tend to be higher, and when the demands tend to be lower. For instance, the demands may be greater during certain times of the day, or during certain events, and lower during other times of the day. Thus, over time, the processing system may learn to predict when the demands on the spectrum channel may increase or decrease at some future time, and may proactively identify a new spectrum channel that is better optimized to meet the change in demands. The processing system may send commands to the CU and the DU to terminate use of an existing spectrum channel and reestablish a connection through the new spectrum channel (potentially at a specified time).

Although not expressly specified above, one or more steps of the method 200 or the method 300 may include a storing, displaying, and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

FIG. 4 depicts a high-level block diagram of a computing device specifically programmed to perform the functions described herein. For example, any one or more components or devices illustrated in FIG. 1A or 1B or described in connection with the method 200 or the method 300 may be implemented as the system 400. For instance, the SDAOC 116 of FIGS. 1A and 1B, or any of the CUs 108 or DUs 110 of FIGS. 1A and 1B, could be implemented as illustrated in FIG. 4.

As depicted in FIG. 4, the system 400 comprises a hardware processor element 402, a memory 404, a module 405 for configuring a spectrum channel between a centralized unit and a distributed unit of a fronthaul optical network, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for configuring a spectrum channel between a centralized unit and a distributed unit of a fronthaul optical network may include circuitry and/or logic for performing special purpose functions relating to detecting and isolating wavelengths of optical transmissions. The input/output devices 406 may include, for example, storage devices (including but not limited to, a tape drive, a floppy drive, a hard disk drive or a compact disk drive), a receiver, a transmitter, a transceiver, an electrical interface, an optical interface, a fiber optic communications line, an output port, or a user input device (such as a keyboard, a keypad, a mouse, and the like).

Although only one processor element is shown, it should be noted that the computer may employ a plurality of processor elements. Furthermore, although only one specific-purpose computer is shown in the Figure, if the method(s) as discussed above is implemented in a distributed or parallel manner for a particular illustrative example, i.e., the steps of the above method(s) or the entire method(s) are implemented across multiple or parallel specific-purpose computers, then the specific-purpose computer of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for configuring a spectrum channel between a centralized unit and a distributed unit of a fronthaul optical network (e.g., a software program comprising computer-executable instructions) can be loaded into memory 404 and executed by hardware processor element 402 to implement the steps, functions or operations as discussed above in connection with the example method 200 or example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for configuring a spectrum channel between a centralized unit and a distributed unit of a fronthaul optical network (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
obtaining, by a processing system of a wireless communications core network, a set of parameters describing settings of a centralized unit and a distributed unit of a fronthaul optical network of the wireless communications core network;
executing, by the processing system, a machine learning model that is trained to predict an optimal frequency of a spectrum channel for carrying data between the centralized unit and the distributed unit when the settings of the centralized unit and the distributed unit are configured in accordance with the set of parameters;
identifying, by the processing system, a spectrum channel of a path between the centralized unit and the distributed unit that supports the optimal frequency; and
sending, by the processing system, commands to the centralized unit and the distributed unit that cause the settings of the centralized unit and the distributed unit to be configured to use the spectrum channel of the path for carrying data between the centralized unit and the distributed unit.

2. The method of claim 1, wherein the wireless communications core network comprises a fifth generation core network.

3. The method of claim 2, wherein the fronthaul optical network comprises a passive optical network or a wavelength division multiplexing network.

4. The method of claim 2, wherein the fronthaul optical network comprises a wavelength division multiplexing network.

5. The method of claim 1, wherein the set of parameters identifies specific values for the settings of the centralized unit and the distributed unit.

6. The method of claim 5, wherein the settings relate to at least one of: a data rate, a modulation format, a forward error correction technique, or a data type.

7. The method of claim 1, further comprising:
obtaining, by the processing system, prior to the executing, a rule that is applied to an operation of the fronthaul optical network.

8. The method of claim 7, wherein the rule is provided as an additional input to the machine learning model.

9. The method of claim 8, wherein the rule specifies a threshold performance metric that the wireless communications core network is to satisfy.

10. The method of claim 9, wherein the threshold performance metric is related to a service level agreement.

11. The method of claim 1, wherein the spectrum channel of the path comprises one of a plurality of spectrum channels of an optical fiber core that connects the centralized unit to the distributed unit.

12. The method of claim 11, wherein the plurality of spectrum channels includes spectrum channels that support different frequencies.

13. The method of claim 1, further comprising:
repeating the obtaining, the executing, the identifying, and the sending for another centralized unit and another distributed unit of the fronthaul optical network.

14. The method of claim 1, further comprising:
repeating the obtaining, the executing, the identifying, and the sending for the centralized unit and another distributed unit of the fronthaul optical network.

15. The method of claim 14, wherein the repeating results in another spectrum channel being identified for carrying data between the centralized unit and the another distributed unit, and a frequency supported by the spectrum channel is different than a frequency supported by the another spectrum channel.

16. The method of claim 1, wherein the processing system is part of a software defined access optical controller that is communicatively coupled to the centralized unit and the distributed unit.

17. The method of claim 1, wherein the processing system predicts a future change in data carried over the spectrum channel of the path between the centralized unit and the distributed unit.

18. The method of claim 17, wherein the processing system sends commands to the centralized unit and the distributed unit to utilize a new spectrum channel that is better optimized to carry the data between the centralized unit and the distributed unit in light of the future change.

19. A non-transitory computer-readable medium storing instructions which, when executed by a processing system of a wireless communications core network including at least one processor, cause the processing system to perform operations, the operations comprising:
obtaining a set of parameters describing settings of a centralized unit and a distributed unit of a fronthaul optical network of the wireless communications core network;
executing a machine learning model that is trained to predict an optimal frequency of a spectrum channel for carrying data between the centralized unit and the distributed unit when the settings of the centralized unit and the distributed unit are configured in accordance with the set of parameters;
identifying a spectrum channel of a path between the centralized unit and the distributed unit that supports the optimal frequency; and
sending commands to the centralized unit and the distributed unit that cause the settings of the centralized unit and the distributed unit to be configured to use the spectrum channel of the path for carrying data between the centralized unit and the distributed unit.

20. An apparatus comprising:
a processor of a wireless communications core network; and
a non-transitory computer-readable medium storing instructions which, when executed by the processor, cause the processor to perform operations, the operations comprising:
obtaining a set of parameters describing settings of a centralized unit and a distributed unit of a fronthaul optical network of the wireless communications core network;
executing a machine learning model that is trained to predict an optimal frequency of a spectrum channel for carrying data between the centralized unit and the distributed unit when the settings of the centralized unit and the distributed unit are configured in accordance with the set of parameters;
identifying a spectrum channel of a path between the centralized unit and the distributed unit that supports the optimal frequency; and
sending commands to the centralized unit and the distributed unit that cause the settings of the centralized unit and the distributed unit to be configured to use the spectrum channel of the path for carrying data between the centralized unit and the distributed unit.
